(19) United States
(12) Patent Application Publication
(10) Pub. No.: US 2013/0253257 A1
(43) Pub. Date: Sep. 26, 2013

(54) PERSONAL COMFORT DEVICE

(71) Applicant: Reza Kalhory, Toronto (CA)

(72) Inventor: Reza Kalhory, Toronto (CA)

(21) Appl. No.: 13/850,521

(22) Filed: Mar. 26, 2013

Related U.S. Application Data
(60) Provisional application No. 61/615,547, filed on Mar. 26, 2012.

(51) Int. Cl. A61H 39/04

(52) U.S. Cl. CPC A61H 39/04
USPC 600/27; 606/204

(57) ABSTRACT

A headband for the treatment of headaches and the like consists of a length of elasticized fabric with hook and loop separable fasteners at its ends for adjustable pressured securement about a user's head. A mask for the user's eyes is detachable secured to the band. A pocket in the band as well as a pocket in the eye mask are adapted to receive a bag of granules that focuses the pressure of the band on a selected area of the head or hot and cold packs, scent packets or magnet strips.

### CROSS-REFERENCE TO RELATED APPLICATIONS

This Application claims the benefit of U.S. Provisional Application 61/615,547 filed on Mar. 26, 2012.

### FIELD OF THE INVENTION

The invention relates to the field of personal health and wellness accessories.

### BACKGROUND OF THE INVENTION

Many persons suffer from headaches. It is common for a person suffering from a headache to self-medicate with a cold compress.

### SUMMARY OF THE INVENTION

Apparatus forms one aspect of the present invention. The apparatus is for use by a person and comprises a headband and a force-focuser. The headband at least substantially encircles the head of the person in use. The force-focuser, in use, is urged against the head of the person by the headband. The headband and the force-focuser are adapted to, in use, apply force to at least substantially all portions of the head surface that are overlaid by the headband and/or the force-focuser. The headband is adjustable to vary, in the aggregate, the force applied to said at least substantially all portions of the head surface. The force-focuser is adapted to permit localized variation of the force applied by the headband and force-focuser in use.

According to another aspect of the invention, the force-focuser can be releasably coupled to the headband.

According to another aspect of the invention, the headband can include an elongate pocket; the force-focuser can include an elongate bag and a plurality of granules sealed within the bag; and the force-focuser can be releasably coupled to the headband by insertion of the bag into the pocket.

According to another aspect of the invention, the granules can be oats.

According to another aspect of the invention: the two or more seams can be defined in the bag; the seams can be spaced apart lengthwise of the bag such that the bag defines a plurality of compartments; and the seams can extend only partially across the bag such that the compartments communicate with one another, to permit the granule loading in each bag to be varied.

According to another aspect of the invention, the apparatus can further comprise a reusable hot and cold gel pack having a form factor similar to that of the force-focuser and adapted for insertion into the pocket.

According to another aspect of the invention, the headband can be an elasticized fabric band having hook and loop fasteners at the ends thereof to provide for said adjustment.

According to another aspect of the invention, the apparatus can further comprise a mask fixedly coupled to the headband and adapted to overlie the eyes of the person in use.

According to another aspect of the invention, the mask can include a mask pocket.

According to another aspect of the invention, the apparatus can further comprising a further bag of granules, the further bag being adapted to be inserted into the mask pocket.

According to another aspect of the invention, the apparatus can further comprise a further reusable hot and cold gel pack having a form factor similar to that of the further bag of granules.

According to another aspect of the invention, the further bag of granules can have a pair of pockets, each pocket being adapted to receive a scent carrier.

According to another aspect of the invention, the apparatus can further comprise a strip having a form factor similar to that of the force-focuser, adapted for insertion into the pocket and which includes a plurality of magnets.

### BRIEF DESCRIPTION OF THE DRAWINGS

FIG. 1 shows a system according to an exemplary embodiment of the invention;

FIG. 2 shows the structure of reference numeral 24 [not visible] inserted in the structure of reference numeral 46;

FIG. 3 is an enlarged view of a portion of the structure indicated with reference numeral 26;

FIG. 4 is a view of the structure of reference numeral 46 in one manner of use;

FIG. 5 is a view of the structure of FIG. 4 from another vantage point; and

FIG. 6 is a view of the structure of FIG. 4 is another manner of use.

### DETAILED DESCRIPTION OF THE PREFERRED EMBODIMENTS

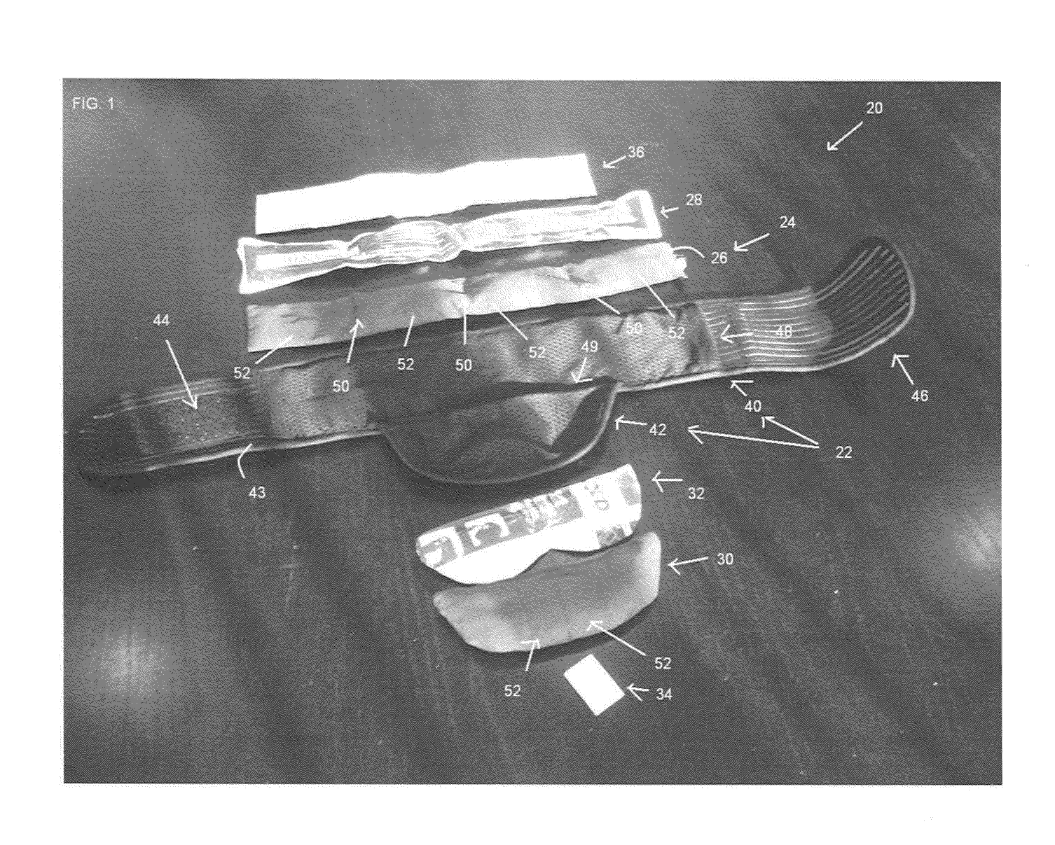

Reference is now made to FIG. 1, which, it will be recalled, shows a system 20 according to an exemplary embodiment of the invention.

The exemplary system 20 will be seen to include: a headband apparatus 22; a force-focuser 24 in the form of a granule-containing bag 26; a reusable hot and cold gel pack 28; a further bag of granules 30; a further reusable hot and cold gel pack 32; a scent strip 34; and a magnet strip 36.

The headband apparatus 22 includes a headband 40 and a mask 42. The headband 40 is an elasticized fabric band 43 having hook 44 and loop 46 fasteners at the ends thereof and an elongate pocket 48. The mask 42 is fixedly coupled to the headband 40 and has a pocket 49 defined therein.

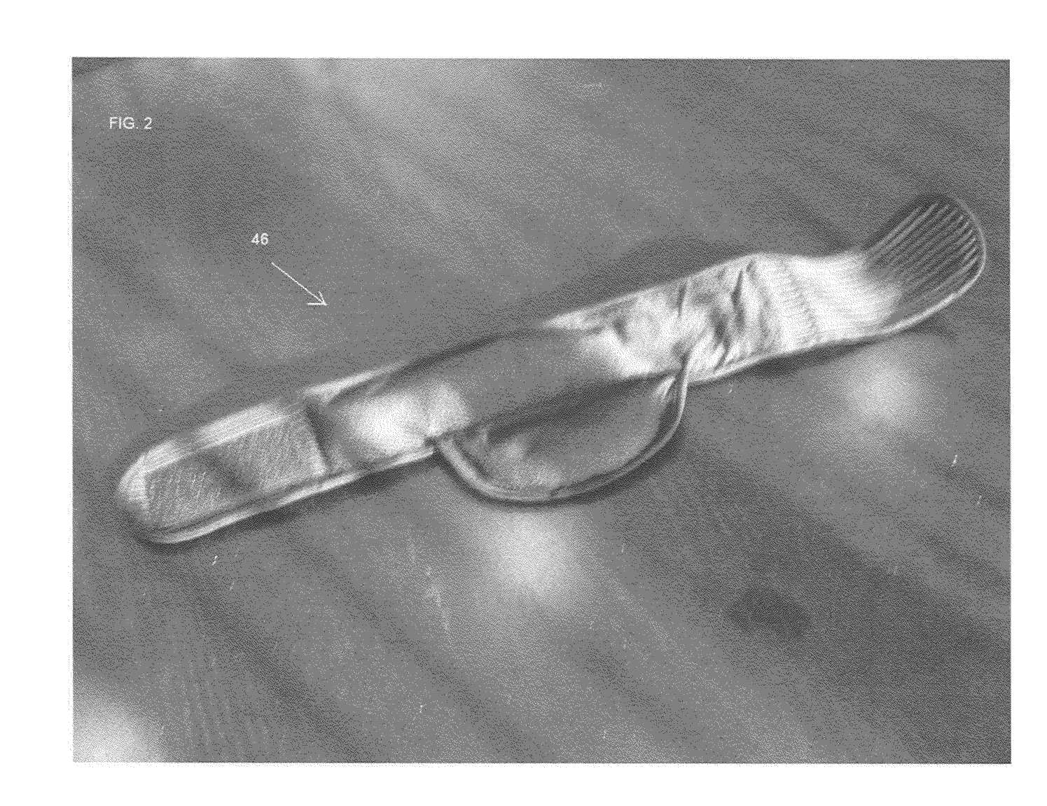

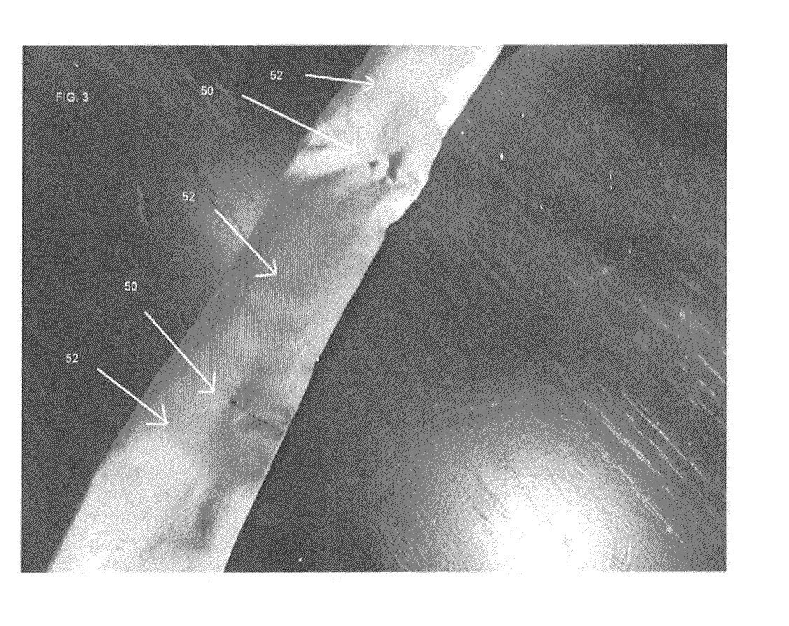

The bag 26 of the force-focuser is elongate and adapted for insertion in the elongate pocket 48, as shown in FIG. 2, and the granules contained in the bag 26 are oats. Two or more seams 50, specifically, three seams, are defined in the bag, and are spaced apart lengthwise of the bag such that the bag defines a plurality of compartments 52, namely, four compartments. As best seen in FIG. 3, seams 50 extend only partially across the bag such that the compartments 52 communicate with one another, to permit the granule loading in each bag to be varied.

The reusable hot and cold gel pack 28 has a form factor similar to that of the force-focuser 24.

The magnet strip 36 has a form factor similar to that of the force-focuser 24 and contains a plurality of magnets (not shown).

The further bag of granules 30 is adapted for insertion in the mask pocket 49, contains oats and has a pair of scent pockets 52.

The scent strip 34 is adapted for insertion in the scent pocket and is adapted to release one of a plurality of scents, specifically, peppermint, lavender and eucalyptus.

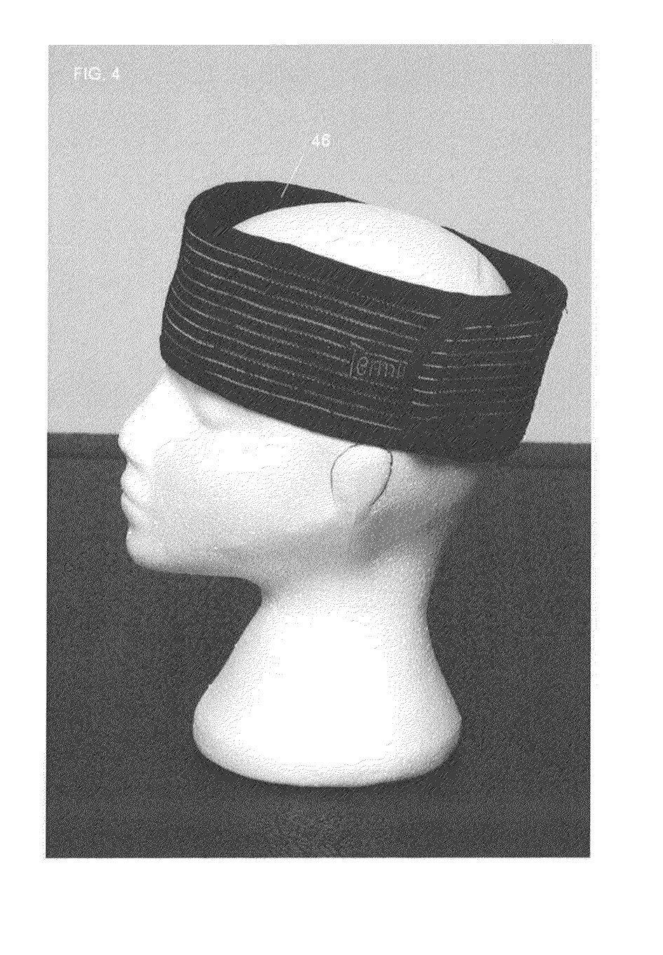

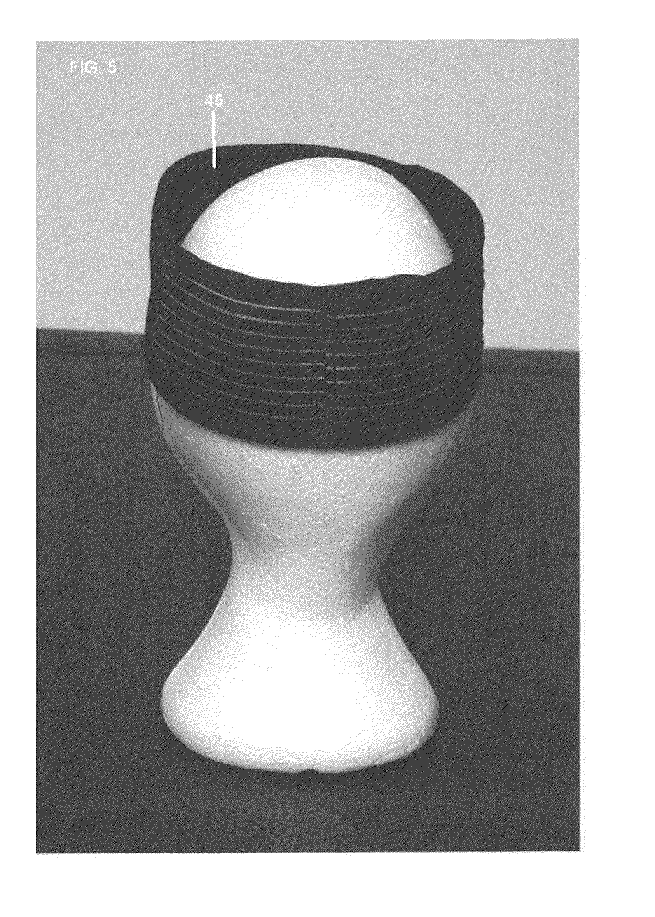

FIGS. 4 and 5 show the headband apparatus 22 in use, namely, with the headband 40 encircling the head of the user. In these views, the mask 42 is tucked under the headband and thus is not visible.

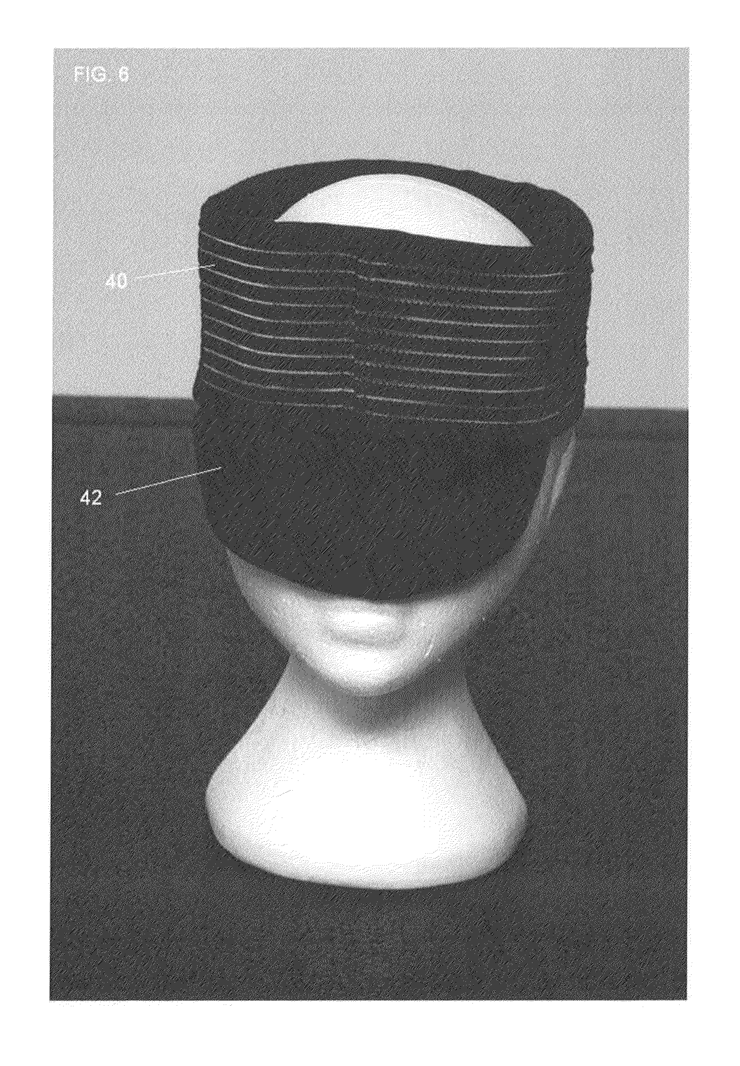

FIG. 6 shows another view, wherein the mask 42 overlies the eyes of the user.

In one manner of use, the force-focuser is inserted into the elongate pocket (not shown), as shown in FIG. 2. In this use, the force-focuser will be urged against the head of the person by the headband and the headband and the force-focuser apply force to at least substantially all portions of the head surface that are overlaid by the headband.

The hook 44 and loop 46 fasteners allow the wearer to vary, in the aggregate, the force applied to said at least substantially all portions of the head surface; varying the granule loading in the compartments permit localized variation of the force applied by the headband and force-focuser in use.

This use has been found to have advantage in the treatment of migraine headaches.

### EXAMPLE ONE

An adult male with a history of migraine headaches noticed the onset of migraine symptoms and migraine pain that was perceived to be in the back of the skull. The granule loading in a previously-chilled force-focuser was adjusted, and the headband was donned and adjusted so as to be as tight as possible without discomfort, so as to provide focused pressure over that surface of the head which was perceived to be the locus of the pain. Within about 7 minutes, the pain and migraine symptoms had ceased.

### EXAMPLE 2

An adult female with a history of cluster headaches experienced a recurrence. The granule loading in a force-focuser was adjusted, and the headband was donned and adjusted so as to be as tight as possible without discomfort, so as to provide focused pressure over the temples. Within minutes, the pain began to subside.

### Other uses

In another use, the hot and cold gel pack 28 takes the place of the force-focuser. This permits the application of pressure in combination with heating and/or cooling and provides comfort to some users.

In another use, the further bag 30 is inserted into the mask pocket. The mass of this bag, as well as the ability to deform associated with the loose granular filling, ensures that the eyes are fully covered, thereby blocking light, which provides comfort to some users.

In yet another use, one or more scent carriers 34 are inserted into the scent pocket 52, thereby to release scent in the vicinity of the nostrils of the wear. This provides comfort to some users.

In yet another use, the further reusable hot and cold gel pack 32 takes the place of the further bag 30 in the mask pocket 49. This provides the advantage of heating and/or cooling to the eyes, while maintaining the light-blocking functionality.

In yet another use, the magnetic-bearing strip 36 takes the place of force-focuser 24; many persons believe in the healing powers of magnets and this use provides comfort to users sharing this belief.

Whereas but a single specific embodiment of the system is herein shown and described, variations are possible.

For example, whereas hook and loop fasteners provide for the adjustment of tension in the aggregate in the exemplary embodiment, this is not essential: the headband could, for example, be provided in varied sizes, thereby to allow the user to purchase a headband that provides the desired tension.

As well, whereas in the exemplary embodiment, oats are used for granules, this is not essential.

Accordingly, the invention should be understood as limited only by the accompanying claims, purposively construed.

1. Apparatus for use by a person, the apparatus comprising:
a headband which at least substantially encircles the head of the person in use;
a force-focuser which, in use, is urged against the head of the person by the headband;
the headband and the force-focuser being adapted to, in use, apply force to at least substantially all portions of the head surface that are overlaid by the headband and/or the force-focuser;
the headband being adjustable to vary, in the aggregate, the force applied to said at least substantially all portions of the head surface; and
the force-focuser being adapted to permit localized variation of the force applied by the headband and force-focuser in use.

2. Apparatus according to claim 1, wherein the force-focuser is releasably coupled to the headband.

3. Apparatus according to claim 1, wherein:
the headband includes an elongate pocket;
the force-focuser includes an elongate bag and a plurality of granules sealed within the bag; and
the force-focuser can be releasably coupled to the headband by insertion of the bag into the pocket.

4. Apparatus according to claim 3, wherein the granules are oats.

5. Apparatus according to claim 3, wherein:
two or more seams are defined in the bag;
the seams are spaced apart lengthwise of the bag such that the bag defines a plurality of compartments; and
the seams extend only partially across the bag such that the compartments communicate with one another, to permit the granule loading in each bag to be varied.

7. Apparatus according to claim 3, further comprising a reusable hot and cold gel pack having a form factor similar to that of the force-focuser and adapted for insertion into the pocket.

8. Apparatus according to claim 1, wherein the headband is an elasticized fabric band having hook and loop fasteners at the ends thereof to provide for said adjustment.

9. Apparatus according to claim 1, further comprising a mask fixedly coupled to the headband and adapted to overlie the eyes of the person in use.

10. Apparatus according to claim 9, wherein the mask includes a mask pocket.

11. Apparatus according to claim 10, further comprising a further bag of granules, the further bag being adapted to be inserted into the mask pocket.

12. Apparatus according to claim 11, further comprise a further reusable hot and cold gel pack having a form factor similar to that of the further bag of granules.

13. Apparatus according to claim 11, wherein the further bag of granules has a pair of pockets, each pocket being adapted to receive a scent carrier.

14. Apparatus according to claim 2, further comprising a strip having a form factor similar to that of the force-focuser, adapted for insertion into the pocket and which includes a plurality of magnets.

15. Apparatus for treatment of headaches and the like, comprising:
an elongated headband formed of an elasticized fabric and having complimentary hook and loop fasteners fixed to its opposite ends for adjustably securing the headband about a user's head with an intermediate section of the headband extending over the user's forehead;
a planar mask releasably secured to said intermediate section of the headband so as to project over the eyes of the user when the headband is secured over the user's head;
a first pocket having an opening formed in said intermediate section of the headband on the side of the headband which bears against the user's forehead when the headband is secured about the user's head;
a force-focuser comprising a bag filled with granules sized to fit within said first pocket so as to bear against a section of the user's head;
a reusable hot and cold pact sized to fit within said first pocket to apply heat and/or cold to the user's head;
a second pocket in the mask;
scent packets sized to fit within said second pocket; and
a strip carrying magnets sized for insertion in either said first or second pocket.

16. The apparatus of claim 15 wherein a plurality of seams are formed in said force-focusing bag, the seams being spaced apart lengthwise of said bag to form a plurality of compartments in the bag, and the seams extend only partially across said bag, to permit circulation of the granule loading in each compartment to vary.
